(19) United States
(12) Patent Application Publication
(10) Pub. No.: US 2019/0265934 A1
(43) Pub. Date: Aug. 29, 2019

(54) MEDIA-LINKED WEARABLE DEVICE AND METHOD

(71) Applicant: EUTZI, LLC, Charlotte, NC (US)

(72) Inventor: Kristen Faye Borel, Charlotte, NC (US)

(21) Appl. No.: 16/285,927

(22) Filed: Feb. 26, 2019

Related U.S. Application Data
(60) Provisional application No. 62/636,486, filed on Feb. 28, 2018.

(51) Int. Cl. G06F 3/14; G09G 3/20; H04B 1/3827; H04W 4/80; H04W 4/21

(52) U.S. Cl. CPC G06F 3/14; G09G 3/2003; H04W 4/21; H04W 4/80; H04B 1/385

(57) ABSTRACT

A wearable accessory has a display responsive to external inputs.

### BACKGROUND OF THE INVENTION

This invention relates generally to wearable devices, and more particularly to a wearable electronic accessory with a display linked to social media.

It is known to make wearable devices such as jewelry and personal accessories which are configured to convey some aspect of the wearer's physical or psychological status. These are referred to generally herein as “mood devices”. One common example is the so-called “mood ring” which contains a material that changes color in response to the user's skin temperature.

One problem with existing mood devices is that they are only capable of displaying information directly sensed or received from the wearer.

### BRIEF SUMMARY OF THE INVENTION

This problem is addressed by a wearable accessory having a display responsive to external inputs.

### BRIEF DESCRIPTION OF THE DRAWINGS

The invention may be best understood by reference to the following description taken in conjunction with the accompanying drawing figures, in which:

FIG. 1 is a schematic diagram of an exemplary media-linked wearable accessory system;

FIG. 2 is a schematic perspective view of an exemplary wearable accessory.

### DETAILED DESCRIPTION OF THE INVENTION

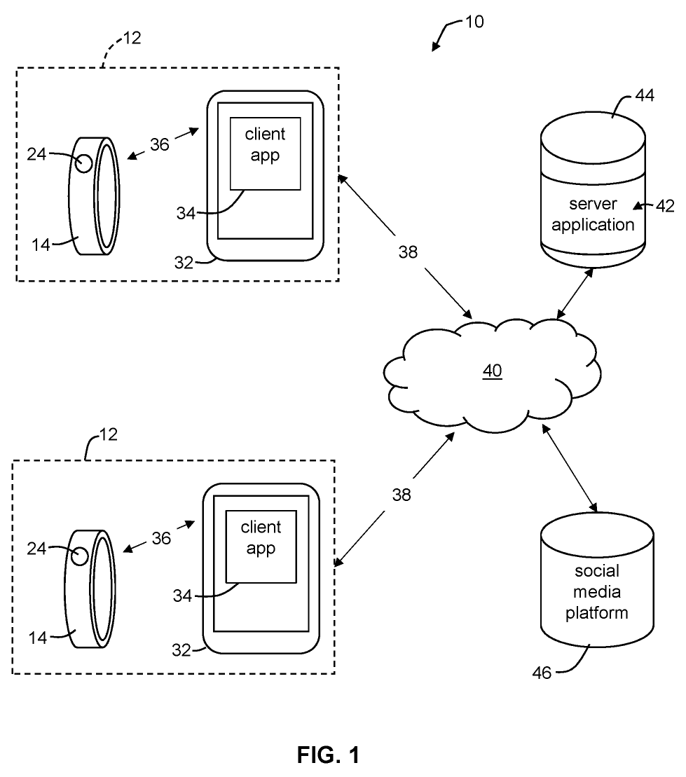

Referring to the drawings wherein identical reference numerals denote the same elements throughout the various views, FIG. 1 illustrates an exemplary media-linked wearable accessory system 10 for use by a plurality of users 12. In the context of this invention, a “user” may refer to an individual human user, or to an account used by a business establishment.

Each user of the system 10 may be provisioned with a wearable accessory 14. As used herein, the term “wearable accessory” refers to an object which may be worn or carried by a human user in such a manner that at least a part of the object is externally visible. As used herein, the term “wear” or “worn” generally refers to the act of transporting or supporting an object without actively lifting or grasping it with the user's hands. For example, a bracelet may be worn by sliding it over the user's hand, onto the user's wrist.

Nonlimiting examples of wearable accessories include: jewelry (such as rings, bracelets, brooches, or necklaces), watches and timepieces, buckles and clasps, and personal electronics (such as earpieces or headsets). The wearable accessory 14 may be configured to be worn or carried directly, or may be configured as a portion of another object that is worn or carried by the user (for example a buckle of a woman's handbag).

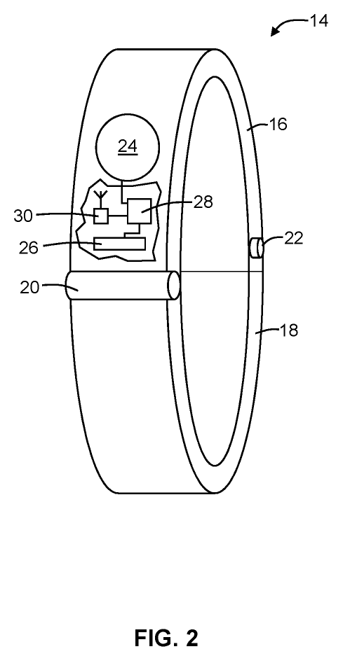

In the illustrated example (see FIG. 2), the wearable accessory 14 is a bracelet comprising a roughly cylindrical shape made up of two sections 16, 18 pivoted together by a hinge 20, and provided with a releasable latch 22 to hold the two sections 16, 18 in a closed position

The wearable accessory 14 includes a display 24 operable to display various colors. For example, one or more incandescent lights, a multicolor light emitting diode (“LED”), or a group of LEDs of different colors could be used to provide the display 24. As seen in FIG. 2, the wearable accessory 14 would also include an appropriate electrical power source 26 such as a battery, a microprocessor 28 operable to receive commands, execute code, and drive the display 24, and a transceiver 30 for short-range communication.

Referring back to FIG. 1, the wearable accessory 14 is intended for use in conjunction with a conventional mobile computing device 32. The mobile computing device 32 includes a microprocessor operable to execute programmed instructions, and supporting components such as a power source (e.g. battery), input/output devices (e.g. keyboard, touchscreen display, microphone, speakers), and one or more transceivers operable over various wireless protocols such as BLUETOOTH, Wi-Fi, and/or cellular networks. Nonlimiting examples of suitable mobile computing devices include laptop computers, tablet computers, “smart watches”, and “smartphones”. In the illustrated example, the mobile computing device 32 is a conventional smartphone. The mobile computing device 32 is provisioned with a client media software program (also referred to as a “client application” or “client app” 34) containing appropriate programming for sending commands to the wearable accessory 14 to display a particular color on the display, based on preprogrammed rules.

The wearable accessory 14 communicates with the mobile computing device 32 over a short-range communications channel 36 using a conventional wireless communications protocol such as BLUETOOTH.

The mobile computing device 32 is connected by a communications channel 38 such as Wi-Fi to a wide area network 40 such as the Internet.

The system 10 includes software server application 42 which communicates with the client app 34 through the wide area network 40. It will be understood that the server app 42 may be hosted on one or more servers or individual user devices, which are connected to the wide area network 40. A single server 44 hosting the server app 42 is depicted schematically in block diagram format.

One or more social media platforms 46 are also connected to the wide area network 40. As used herein, the term “social media platform” refers to a combination of hardware and/or software which is used to provide a predetermined framework for digital intercommunication amongst a plurality of users. One example of a known social media platform is FACEBOOK. The social media platform 46 is depicted schematically in block diagram format. It will be understood that social media platforms 46 may be hosted on one or more servers or individual user devices, which are connected to the wide area network 40.

The wide area network 40 provides a common channel for interchange of information among and between the users 12, the server application 42, and the social media platform 46.

One or more communications routes may be established amongst the users 12, the server application 42, and/or the social media platform 46. For example, a user 12 may grant permission to the server application 42 to access the user's account associated with the social media platform 46. In operation, the server application 42 may then receive information from the social media platform 46, such as status identifiers, the content of posts, etc.

The server application 42 and/or the client app 34 are programmed with one or more rules or algorithms that function to select a color to be displayed on a specific user's wearable accessory 14 and then to command the display 24 of that wearable accessory 14 to display the selected color.

For example, one rule or algorithm may cause the system 10 to extract or obtain a status identifier such as an adjective or symbol, from operation of the social media platform 46. A chart or database may be provided listing adjectives that describe various moods, with a color correlated to each mood.

For example, the color red could be correlated to adjectives such as “love”, “strong”, etc., while the color blue could be correlated to adjectives such as “alone”, “cool”, etc. A correlation may be provided for each available color. In another example, a symbol such as the emoji symbol for “delighted” could be correlated to the color yellow.

In operation, the system 10 would extract or obtain the status identifier, determine the appropriate color by reference to the chart or database, and then cause the display 24 to display that color. In practice, the determination of the appropriate color would be made by the server application 42, the client app 34, or some combination thereof, and the software command to display the appropriate color would be relayed from the mobile computing device 32 to the wearable accessory 14. Optionally, the selected color could be displayed as part of the screen background or wallpaper of the mobile computing device 32.

A significant difference between the present system and other systems which attempt to depict a user's mood or status is that the system 10 is able to determine a status and a color to be shown on the display 24 using information from third parties; that is from other users 12.

As part of the initial configuration of the system 10, a first user 12 would use the client app 34 to select a level of participation in system functions, and/or to grant permission to other specific users or groups of users. These permissions would describe the ability of the other users 12 to affect the first user's wearable accessory 14 through their use of the social media platform 46.

As one example of the operation, a first user 12 may post a picture on the social media platform 46. The term “post” refers to using the inherent functionality of the social media platform 46 to upload a digital image which is then available for viewing and/or comment by other users of the social media platform 46. It will be understood that access to the picture and other related functions are governed by the internal rules and programming of the social media platform 46.

One of the functions available in the social media platform is for other users to “react” to the post, for example, by providing it with a rating, a symbol (e.g. “emoji”), or a text comment.

The server application 42 is operable to monitor the reactions of the other users 12 and to use the content of those reactions as input for the rule or algorithm described above. Each time another user 12 reacts to the post, their reaction would trigger one of the rules, causing the first user's display 24 to change colors.

The rule or algorithm could also be triggered by a user being mentioned in another user's social media post. For example, a post made on the social media platform 46 by a first user named John Doe might read: “John Doe is feeling [adjective]—with Jane Smith”. Whichever adjective was chosen to describe the mood would be related to a certain color, by reference to the chart or database described above. Jane Smith's display 24 would change to that color.

Optionally, an algorithm or formula would be used to determine the appropriate color for a specific user 12 based on the inputs from multiple other users 12. For example, if several users 12 indicated different moods for a particular user (corresponding to different colors), the color ultimately selected might be a weighted average or a mixture of the different colors.

Optionally, each user 12 would only have the ability to give another user one mood at a time. So, if a first user 12 posted about a second user's mood, and then posted about the second user's mood again later that day, the most recent mood chosen would be the one reflected on the second user's display 24. This feature would make harassment, bullying, bombardment, and altering an individual's/establishment's display color unfairly nearly impossible.

Optionally, data from the client app 34 and/or server application 42 can be applied to online maps (e.g. Google Maps) creating color demographics. This would give users 12 the ability to view any given location's community perspective.

Optionally, the system 10 could run on a predetermined time loop, for example 24 hours, giving each interaction the ability to affect an individual user's color for the duration of 24 hours. This feature would help keep individual/establishment perspectives current.

Optionally, the duration of time an interaction can affect a user's color could be based on a specific amount of interactions allowed to affect an individual's color at one time. So once the interaction limit has been reached, a new reaction would be received, and the oldest interaction would no longer be reflected.

Optionally, the system 10 can be programmed to recommend and notify individuals and/or establishments of nearby people/places having corresponding colors.

Optionally, the system 10 can be programmed with the ability to share notifications/posts from the client app 34 to connected social media networks, for example “6 people said you were in a silly mood this month”.

Other functions and options may be provided in the client app 34, such as: providing a main newsfeed, providing controls for turning notification sounds on/off, changing the volume of notification sounds, selecting a vibration pattern for notifications, customizing Bluetooth and/or mobile notifications for specific individual/establishments, changing the display hue, brightness, contrast, etc. Within the client app 34, a user could also block/add friends from the client app 34 without having to block them on other social media networks. The client app 34 operating on the mobile computing device 32 would also enable the user 12 to see all of his or her reactions and interactions each day. The user can also check the status, mood color, etc. of the user's friends through the client app 34.

The wearable accessory 14 and system 10 described herein will help to bring greater insight to individuals/establishments, and how they affect the world around them on a day-to-day basis.

The foregoing has described media-linked wearable devices and a system and method for their use. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A wearable accessory, comprising a display responsive to external inputs.
